(19) United States
(12) Patent Application Publication
(10) Pub. No.: US 2016/0033933 A1
(43) Pub. Date: Feb. 4, 2016

(54) IMAGE FORMING APPARATUS, CARTRIDGE, AND METHOD FOR MOUNTING CARTRIDGE TO IMAGE FORMING APPARATUS

(71) Applicant: FUNAI ELECTRIC CO., LTD., Osaka (JP)

(72) Inventor: Daisuke Takasaka, Osaka (JP)

(73) Assignee: FUNAI ELECTRIC CO., LTD., Osaka (JP)

(21) Appl. No.: 14/811,391

(22) Filed: Jul. 28, 2015

(30) Foreign Application Priority Data
Jul. 29, 2014 (JP) 2014-154190

(51) Int. Cl. G03G 21/18

(52) U.S. Cl. CPC G03G 21/18

(57) ABSTRACT

An image forming apparatus that uses a cartridge, includes a protruding portion that engages with an engaging portion of the cartridge; and a first gear that engages with a second gear of the cartridge, wherein while the cartridge is being inserted into the image forming apparatus, the protruding portion maintains a distance of separation, between the first gear and the second gear in a direction crossing a face that transports a recording medium, until the protruding portion engages with the engaging portion.

### TECHNICAL FIELD

The present invention generally relates to a cartridge, an image forming apparatus with the cartridge, and a method for mounting the cartridge to the image forming apparatus.

### BACKGROUND ART

Conventional laser printers form an electrostatic latent image on the surface of a photoreceptor roller (also called a photoreceptor drum) using laser light. Then, a toner image is formed by adhering toner to the electrostatic latent image formed on the photoreceptor roller by using a developing roller. The toner image is transferred to a recording medium by a transfer roller provided facing the photoreceptor roller.

The developing roller and photoreceptor roller are included in the cartridge detachable from the printer. Therefore, it is necessary to transfer power for rotating the developing roller and the photoreceptor roller from the driving source to the cartridge.

Generally, a gear is used for transferring power to a cartridge. Specifically, with the cartridge mounted on the printer, a first gear provided on the printer engages with a second gear provided on the cartridge.

For example, in Patent Literature 1, a guiderail guides the movement of the cartridge so that the first gear and the second gear do not come in contact and become damaged when the cartridge is being mounted onto the printer.

### CITATION LIST

### Patent Literature

[Patent Literature 1] Japanese Unexamined Patent Application Publication No. 1994-317960

However, as in Patent Document 1, when a guiderail is provided on the inner side face of the printer, the flexibility of the design of the printer is reduced. Moreover, the location of the contact terminal of the printer and the cartridge, or the location of the transferring member for transferring power to the cartridge is limited by the guiderail provided on the inner side face of the printer. Furthermore, the width of the printer may increase by the guiderail provided on the inner side face of the printer.

### SUMMARY OF THE INVENTION

A printer according to one or more embodiments of the present invention can suppress the lowering of flexibility in design by a mechanism for assisting the detaching of the cartridge to the printer.

A printer according to one or more embodiments of the present invention may comprise a cartridge having a developing powder, provided with a mounting face with a transfer roller exposed in a position opposing a photoreceptor roller included in the cartridge, a first gear engaging a second gear included in the cartridge, the second gear being connected to the photoreceptor roller, and at least one protruding portion protruding from the mounting face, the at least one protruding portion restricting the distance between the first gear and the second gear in a direction crossing the mounting face by contacting the cartridge when the cartridge proceeds in a direction crossing the axis direction of the transfer roller until a position where the first gear and the second gear engage when the cartridge is mounted to the printer.

According to this configuration, the distance between the first gear and the second gear during the progression of the cartridge may be restricted by the protruding portion protruding from the mounting face. That is, the first gear and the second gear can be separated in a direction crossing the mounting face so that the first gear and second gear do not contact when the cartridge is proceeding. Therefore, the detaching of the cartridge to the printer can appropriately be assisted and the lowering of the flexibility in design of the printer can be suppressed even if there is no mechanism provided on the inner side face of the printer for preventing the contact of the first gear and the second gear.

According to one or more embodiments of the present invention, for example, the at least one protruding portion may be provided between the transfer roller and the first gear in the axis direction of the transfer roller.

According to this configuration, the protruding portion can be provided between the transfer roller and the first gear in the axis direction of the transfer roller. Therefore, the protruding portion can be disposed in a region where a bearing of the transfer roller is disposed, or a region arranged in a direction that crosses the axis direction of that region and the transfer roller. As a result, the dimensions of the printer in the axis direction of the transfer roller can be reduced, thereby contributing to the size reduction of the printer.

According to one or more embodiments of the present invention, for example, the at least one protruding portion may rotatably hold the transfer roller and may include a first protruding portion protruding from the mounting face and a second protruding portion protruding from the mounting face, being provided arranged with the first protruding portion in a direction crossing the axis direction of the transfer roller on the mounting face.

According to this configuration, the protruding portion can rotatably hold the transfer roller. That is to say, that a bearing of the transfer roller can be used as the protruding portion for restricting the distance between the first gear and the second gear. Therefore, the length of the second protruding portion in a direction crossing the axis direction of the transfer roller can be reduced on the mounting face, thereby contributing to the size reduction of the printer.

According to one or more embodiments of the present invention, for example, the first protruding portion may have elasticity in a direction crossing the mounting face.

According to this configuration, the first protruding portion can have elasticity in a direction crossing the mounting face. Therefore, shock can be alleviated when the cartridge contacts the protruding portion, and the occurrence of damage to the printer and the cartridge can be reduced.

According to one or more embodiments of the present invention, for example, the at least one protruding portion may engage with an engaging portion formed on the cartridge in a direction crossing the axis direction of the transfer roller on the mounting face with the cartridge mounted to the printer.

According to this configuration, the protruding portion of the printer and the engaging portion of the cartridge can be engaged in a direction crossing the axis direction of the transfer roller on the mounting face. Therefore, the protruding portion for restricting the distance between the first gear and the second gear when the cartridge is being mounted can be used as a mechanism for restricting the movement of the cartridge after the cartridge has been mounted.

According to one or more embodiments of the present invention, an image forming apparatus that uses a cartridge, may comprise a protruding portion that engages with an engaging portion of the cartridge; and a first gear that engages with a second gear of the cartridge, wherein while the cartridge is being inserted into the image forming apparatus, the protruding portion may maintain a distance of separation, between the first gear and the second gear in a direction crossing a face that transports a recording medium, until the protruding portion engages with the engaging portion.

According to one or more embodiments of the present invention, a cartridge mounted on an image forming apparatus, may comprises an engaging portion that engages with a protruding portion of the image forming apparatus; a second gear that engages with a first gear of the image forming apparatus, wherein while the cartridge is being inserted into the image forming apparatus, the engaging portion may maintain a distance of separation, between the first gear and the second gear in a direction crossing a face that transports a recording medium, until the engaging portion engages with the protruding portion.

According to one or more embodiments of the present invention, a method for mounting a cartridge to an image forming apparatus, the method may comprise inserting the cartridge into the image forming apparatus; engaging a first engaging portion of the image forming apparatus with a second engaging portion of the cartridge; and engaging a first gear included in the image forming apparatus with a second gear of the cartridge, wherein at least one of the first engaging portion and the second engaging portion protrudes in a direction crossing a face that transports a recording medium; and while the cartridge is being inserted into the image forming apparatus, maintaining a distance of separation between the first gear and the second gear in the direction crossing the face that transports the recording medium, until the first engaging portion engages with the second engaging portion.

The printer according to one or more embodiments of the present invention can suppress the lowering of the flexibility in design by a mechanism for supporting the attaching and detaching of the cartridge to the printer.

### BRIEF DESCRIPTION OF THE DRAWINGS

FIG. 1 is a perspective view illustrating the printer according to one or more embodiments of a first example of the present invention.

FIG. 2 is a perspective view of a portion to which a cartridge is mounted of the printer according to one or more embodiments of the first example of the present invention.

FIG. 3 is an enlarged perspective view of the vicinity of a protruding portion included in the printer according to one or more embodiments of the first example of the present invention.

FIG. 4 is a perspective view of a cartridge according to one or more embodiments of the first example of the present invention.

FIG. 5 is a cross-sectional view illustrating a cartridge mounted to the printer according to one or more embodiments of the first example of the present invention.

FIG. 6A is a perspective view illustrating a mounting process of the cartridge in the printer according to one or more embodiments of the first example of the present invention.

FIG. 6B is a perspective view illustrating a mounting process of the cartridge in the printer according to one or more embodiments of the first example of the present invention.

FIG. 6C is a perspective view illustrating a mounting process of the cartridge in the printer according to one or more embodiments of the first example of the present invention.

FIG. 7 is a diagram illustrating a first protruding portion and elastic member of the printer according to one or more embodiments of a second example of the present invention.

### DETAILED DESCRIPTION OF EMBODIMENTS

Embodiments of the present invention will be described below in detail with reference to the drawings.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

### First Example

A printer according to one or more embodiments of the first example of the present invention may be a printer that can attach/detach a cartridge having a developing powder, and is characterized by the removing mechanism of the cartridge. A printer is an example of an image forming apparatus. The image forming apparatus may be the printer or an MFP (Multi-Function Peripheral) which includes a printing function. Below, the printer according to one or more embodiments of the first example of the present invention will be described in detail with reference to the drawings.

(Configuration of the Printer)

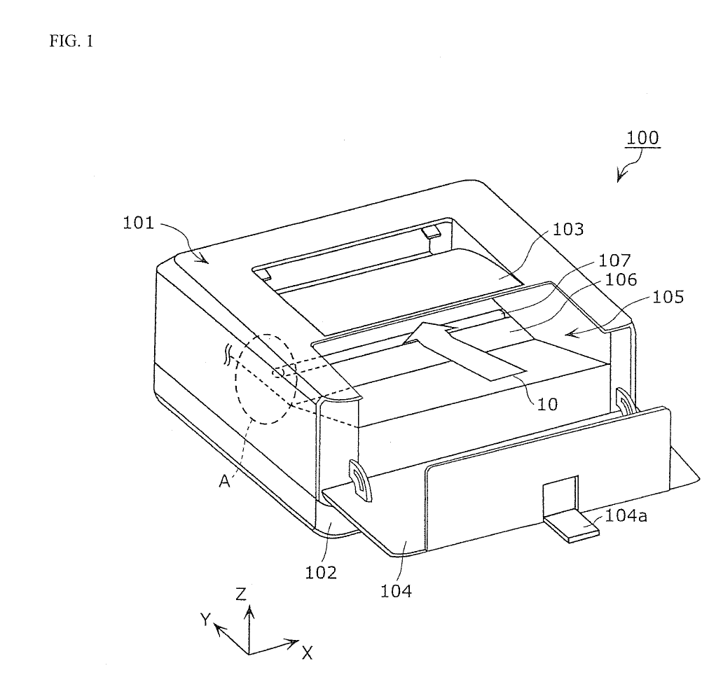

The printer 100 according to embodiments of the present invention will be described below. FIG. 1 is a perspective view illustrating the printer 100 according to one or more embodiments of the first example of the present invention.

According to embodiments of the present invention, an X-axis direction is an axis direction of the transfer roller 107 included in the printer 100. A side away from the printer 100 in the axis direction of the transfer roller 107 will be referred to as an outside in the axis direction of the transfer roller 107. A side approaching a center of the axis of the transfer roller 107 will be referred to as an inside in the axis direction of the transfer roller 107. A Y-axis direction is a direction that crosses the X-axis direction and a direction to which a recording medium is transported (hereinafter transporting direction). A positive side and negative side of the Y-axis will be referred to as a downstream side of the transporting direction and an upstream side of the transporting direction, respectively. A Z-axis direction is a direction that crosses the X-axis and the Y-axis. A positive side and negative side of the Z-axis will be referred to as the upper side and the lower side.

The printer 100 may be, for example, a laser printer. The printer 100 may comprise a housing 101, a paper feeding cassette 102, a paper discharging tray 103, and a front cover 104 as illustrated in FIG. 1.

The paper feeding cassette 102 is provided on a lower portion of the housing 101, and is housed in the housing 101 drawable in the Y-axis direction. The paper feeding cassette 102 stores a recording medium which is sheet-shaped (for example, paper).

The paper discharging tray 103 is provided on the upper face of the housing 101. The recording medium to be printed is discharged from the paper discharging tray 103.

The front cover 104 is a member configuring one portion of the housing 101. The front cover 104 covers one portion of the upper face and one portion of the front face of the housing 101 so as to freely open and close. A user can open the front cover 104 by raising a handle portion 104a provided movably on the upper face of the front cover 104 and pulling in the upstream side of the transporting direction (the negative side of the Y-axis).

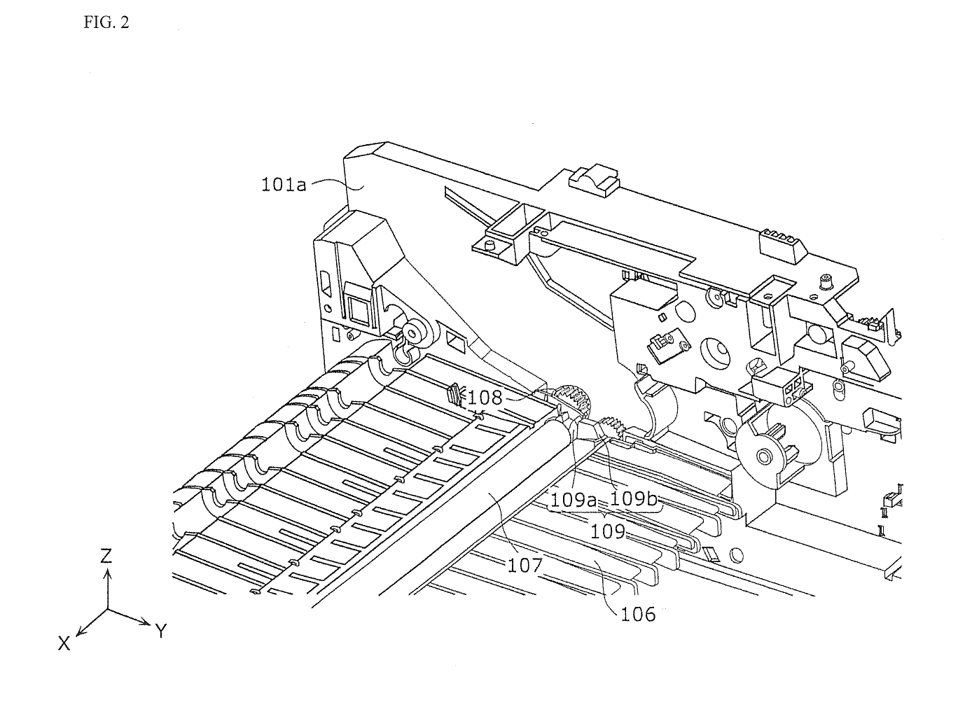

FIG. 2 is a perspective view of the front cover 104 of the printer 100 according to one or more embodiments of the first example of the present invention opened.

As illustrated in FIG. 1, by opening the front cover 104, an insertion opening 105 is exposed for detaching a cartridge 200 described hereafter. The cartridge 200 is mounted to the printer 100 by inserting in a direction of arrow 10 (Y-axis direction) into the insertion opening 105. Furthermore, the cartridge 200 mounted to the printer 100 is removed from the printer 100 by pulling in the direction opposite the arrow 10 from the insertion opening 105.

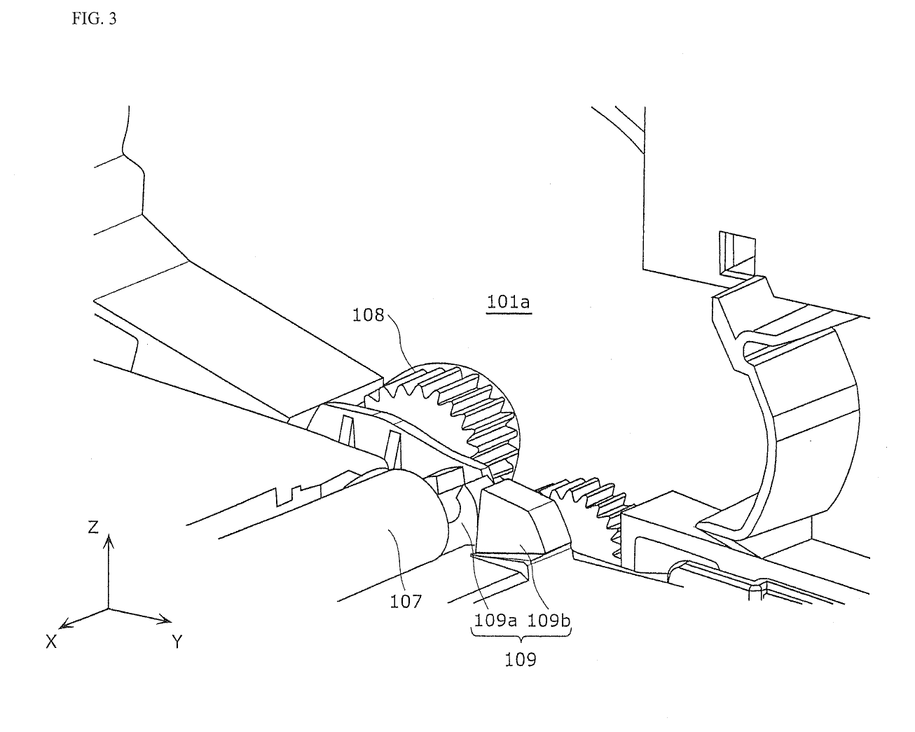

FIG. 2 is a perspective view of a portion to which the cartridge 200 is mounted of the printer 100 according to one or more embodiments of the first example of the present invention. Specifically, FIG. 2 is a perspective view when viewing portion A in FIG. 1 from a different direction from that of FIG. 1. FIG. 3 is an enlarged perspective view of the vicinity of a protruding portion 109 included in the printer 100 according to one or more embodiments of the first example of the present invention.

As illustrated in FIG. 2, the printer 100 may internally comprise a mounting face 106, a transfer roller 107, a first gear 108, and a protruding portion 109.

The mounting face 106 is a face with the cartridge 200 mounted. Specifically, the mounting face 106 is a face substantially parallel to the XY plane. Here, the recording medium is transported in the Y-axis direction on the mounting face 106. The XY plane is a face that transports the recording medium.

The transfer roller 107 is exposed on the mounting face 106 in a position opposing a photoreceptor roller 201 (described hereafter) included in the cartridge 200. In other words, the transfer roller 107 and the photoreceptor roller 201 face each other when the cartridge 200 is mounted to the printer 100.

Specifically, the transfer roller 107 extends in the X-axis direction and is rotatably held around the X-axis. By rotating in the opposite direction of the photoreceptor roller 201, the transfer roller 107 transfers a visible image formed on the surface of the photoreceptor roller 201 to the recording medium that passes in the Y-axis direction between the transfer roller 107 and the photoreceptor roller 201.

The first gear 108 engages a second gear 202 (described hereafter) connected to the photoreceptor roller 201 included in the cartridge 200. The first gear 108 rotates by a driving source (not illustrated) and communicates rotational force to the photoreceptor roller 201 via the second gear 202.

In the present embodiment, the first gear 108 is disposed separated from the transfer roller 107 in the axis direction of the transfer roller 107 (X-axis direction). Specifically, the first gear 108 is attached to a side frame 101a disposed separated from the transfer roller 107 in the X-axis direction.

The protruding portion 109 restricts the distance between the first gear 108 and the second gear 202 in a direction crossing the mounting face 106 (a direction crossing the face that transports a recording medium) (Z-axis direction) by contacting the cartridge 200 when the cartridge 200 proceeds in a direction crossing the axis direction of the transfer roller 107 (Y-axis) until a position where the first gear 108 and the second gear 202 engage when the cartridge 200 is mounted to the printer 100. In other words, the protruding portion 109 maintains the disconnected state of the first gear 108 and the second 202 during the progression of the cartridge 200. That is to say, the protruding portion 109 separates the first gear 108 and the second gear 202 in the Z-axis direction when the cartridge 200 is inserted to the printer 100. In other words, when the cartridge 200 is inserted into the printer 100, the protruding portion 109 maintains a distance of separation between the first gear 108 and the second gear 202 in the direction crossing the face that transports a recording medium until the protruding portion 109 engages with the engaging portion 203 and contacts the cartridge 200.

According to embodiments of the present invention, the protruding portion 109 is disposed between the transfer roller 107 and the first gear 108 in the axis direction of the transfer roller 107 (X-axis direction). In other words, the first gear 108, the protruding portion 109, and the transfer roller 107 are disposed in that order deviating from the X-axis direction. Furthermore, the protruding portion 109 is disposed further on the downstream side in the transporting direction than the first gear 108. That is, the protruding portion 109 is disposed further outside in the axis direction of the transfer roller 107 than the transfer roller 107, and further inside in the axis direction of the transfer roller 107 and further downstream in the transporting direction than the first gear 108. The protruding portion 109 protrudes from the mounting face 106 (the face that transports the recording medium).

For example, the protruding portion 109 includes a first protruding portion 109a and a second protruding portion 109b as illustrated in FIGS. 2 and 3. The first protruding portion 109a rotatably holds the transfer roller 107 and protrudes from the mounting face 106 (the face that transports the recording medium). That is, the first protruding portion 109a may be the bearing of the transfer roller 107.

The second protruding portion 109b is provided lined up with the first protruding portion 109a in a direction crossing (Y-axis direction) the axis direction of the transfer roller 107 (X-axis direction). The second protruding portion 109b is disposed further downstream in the transporting direction than the first protruding portion 109a, and the height from the mounting face 106 is substantially the same as the first protruding portion 109a.

The second protruding portion 109b engages with an engaging portion 203 (described hereafter) formed on the cartridge 200 in a direction (Y-axis direction) crossing the axis direction of the transfer roller 107 on the mounting face 106 with the cartridge 200 mounted to the printer 100. In other words, the second protruding portion 109b limits the cartridge 200 moving to the upstream side in the transporting direction (that is, the direction in which the cartridge 200 is removed from the printer 100) after the cartridge 200 is mounted to the printer 100.

(Configuration of the Cartridge)

The configuration of the cartridge 200 will be described below. The cartridge 200 stores a developing powder (for example, a toner) for making a latent image visible. The cartridge 200 is replaced when the remaining developing powder goes below a threshold amount by printing.

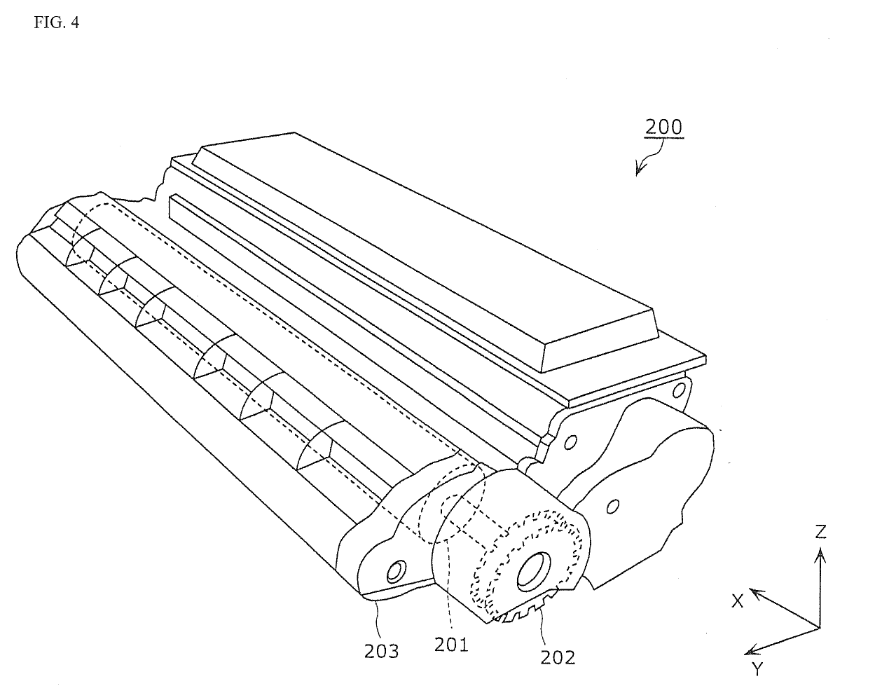

FIG. 4 is a perspective view of the cartridge 200 according to one or more embodiments of the first example of the present invention. In FIG. 4, a portion of the cartridge 200 hidden in the inner portion is illustrated with a dashed line. The cartridge 200 may comprise the photoreceptor roller 201, the second gear 202, and the engaging portion 203.

The photoreceptor roller 201 extends in the X-axis direction and is rotatably held around the X-axis. The cartridge 200 is mounted on a position where the photoreceptor roller 201 faced the transfer roller 107 of the printer 100. The photoreceptor roller 201 may be referred to as a photoreceptor, a photoreceptor drum, or a photoreceptor unit.

In the printing process, an electrostatic latent image is formed on the surface of the photoreceptor roller 201. Then, the electrostatic latent image is made visible by a developing roller (not illustrated) included in the cartridge 200 adhering a developing powder to the electrostatic latent image formed on the photoreceptor roller 201. In other words, a visual image is formed on the surface of the photoreceptor roller 201. The visible image formed on the surface of the photoreceptor roller 201 is transferred to the recording medium that passes between the photoreceptor roller 201 and the transfer roller 107 in the Y-axis direction.

The second gear 202 is connected to the photoreceptor roller 201. The second gear 202 receives power for rotating the photoreceptor 201 from the gear 108 of the printer 100. In other words, the second gear 202 engages the first gear 108.

The engaging portion 203 protrudes downwards on the tip end portion of the cartridge 200. According to embodiments of the present invention, the engaging portion 203 is disposed further downstream in the transporting direction in the cartridge 200 than the photoreceptor roller 201. In other words, the engaging portion 203 is disposed further downstream in the transporting direction than the photoreceptor roller 201 in the direction where the cartridge 200 proceeds (the direction that the cartridge 200 is inserted) (the positive side of the Y-axis direction) when the cartridge 200 is mounted to the printer 100.

The engaging portion 203 contacts the protruding portion 109 of the printer 100 while the cartridge 200 for mounting to the printer 100 proceeds. By this, the first gear 108 and the second gear 202 are restricted in a direction intersecting the mounting face 106 (Z-axis direction) by contacting the cartridge 200 when the cartridge 200 proceeds until a position where the first gear 108 and the second gear 202 engage.

The engaging portion 203 engages with the protruding portion 109 (here, the second protruding portion 109b) of the printer 100 in a direction (Y-axis direction) crossing the axis direction of the transfer roller 107 on the mounting face 106 with the cartridge 200 mounted to the printer 100. In other words, the engaging portion 203 limits the cartridge 200 moving to the upstream side of the transporting direction after the cartridge 200 is mounted to the printer 100.

(State of the Cartridge Mounted to the Printer)

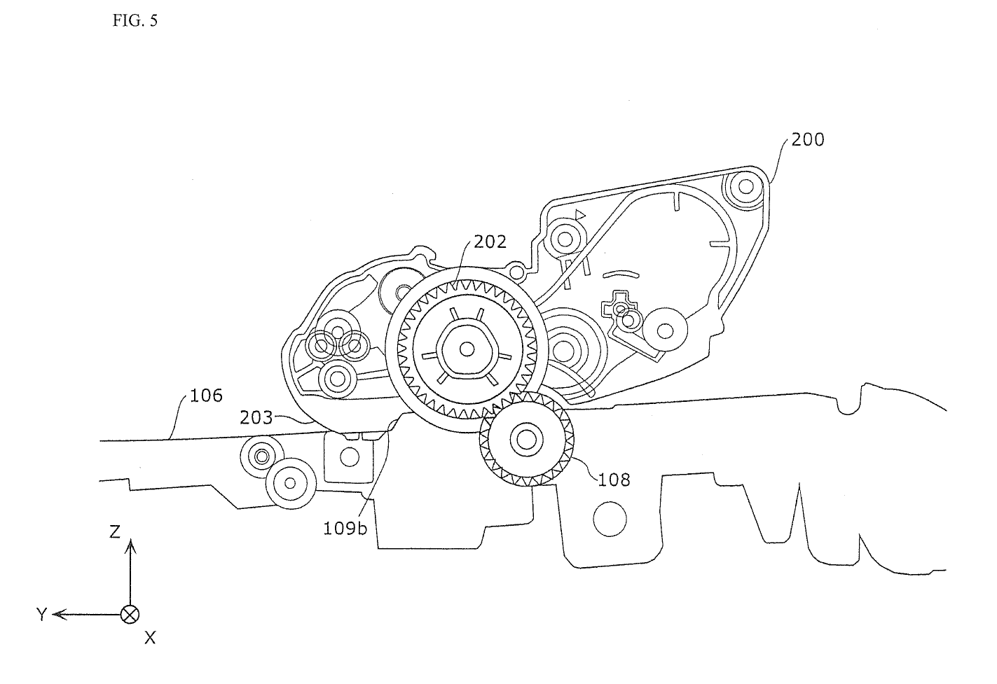

The state of the cartridge 200 mounted to the printer 100 will be described below. FIG. 5 is a cross-sectional view illustrating the cartridge 200 mounted to the printer 100 according to embodiments of the first example of the present invention.

As illustrated in FIG. 5, the first gear 108 of the printer 100 engages the second gear 202 of the cartridge 200 with the cartridge 200 mounted to the printer 100. The first gear 108 is disposed further upstream in the transporting direction than the second gear 202. For example, the first gear 108 engages with the second gear 202 in the upper side of the first gear 108 and in the downstream side in the transporting direction. In other words, the second gear 202 passes the upper portion of the first gear 108 when the cartridge 200 is mounted to the printer 100.

The engaging portion 203 of the cartridge 200 engages with the second protruding portion 109b of the printer 100. For example, the movement of the engaging portion 203 to the upstream side in the transporting direction is limited by being caught on the second protruding portion 109b from the downstream side of the second protruding portion 109b.

(Mounting Process of Cartridge to Printer)

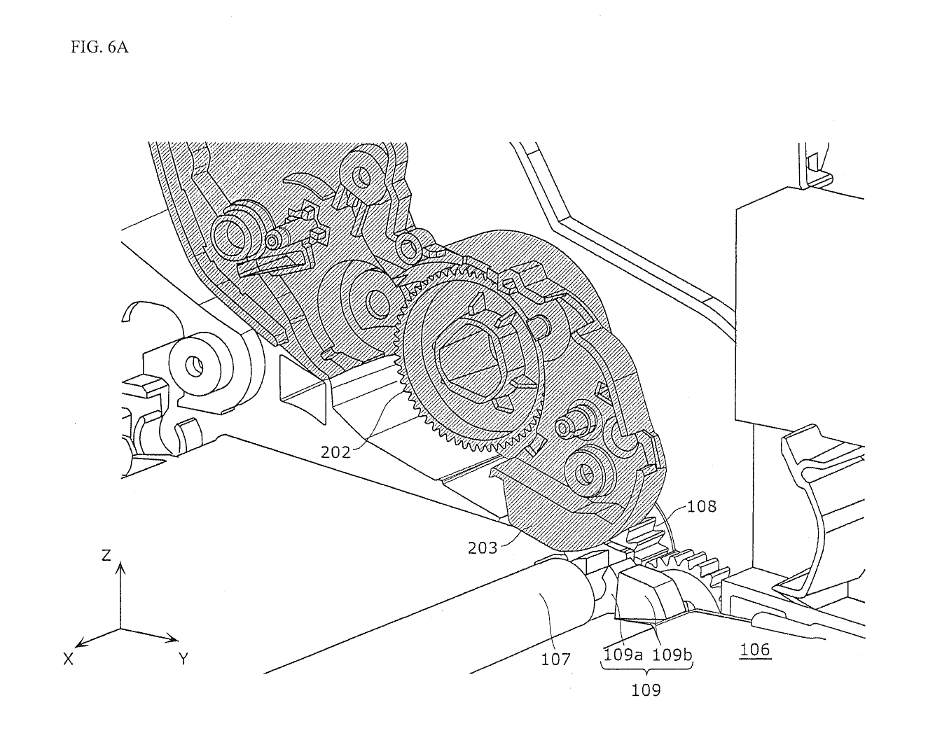

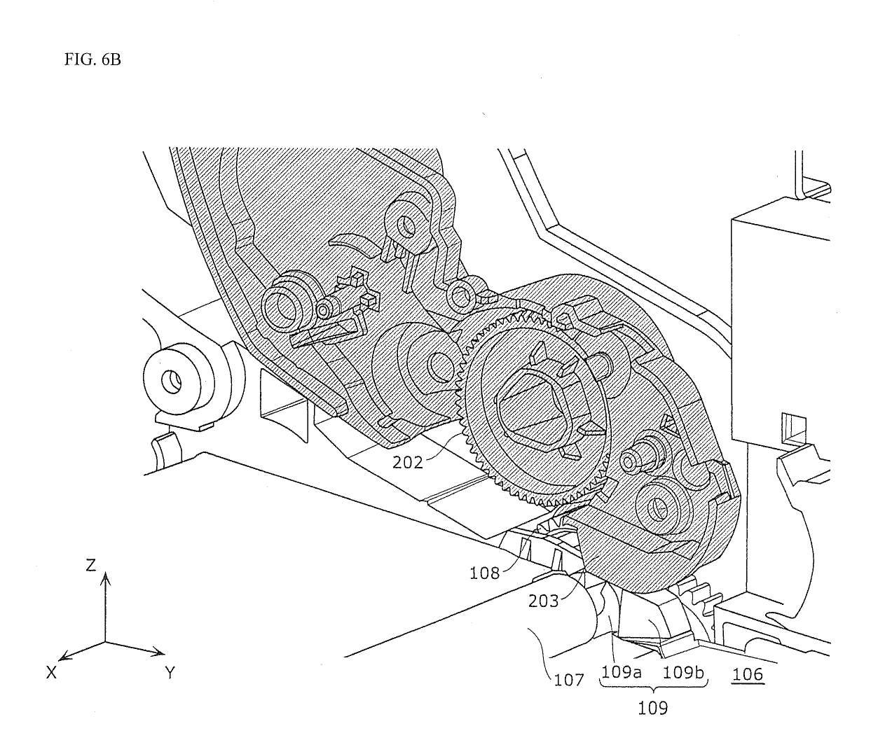

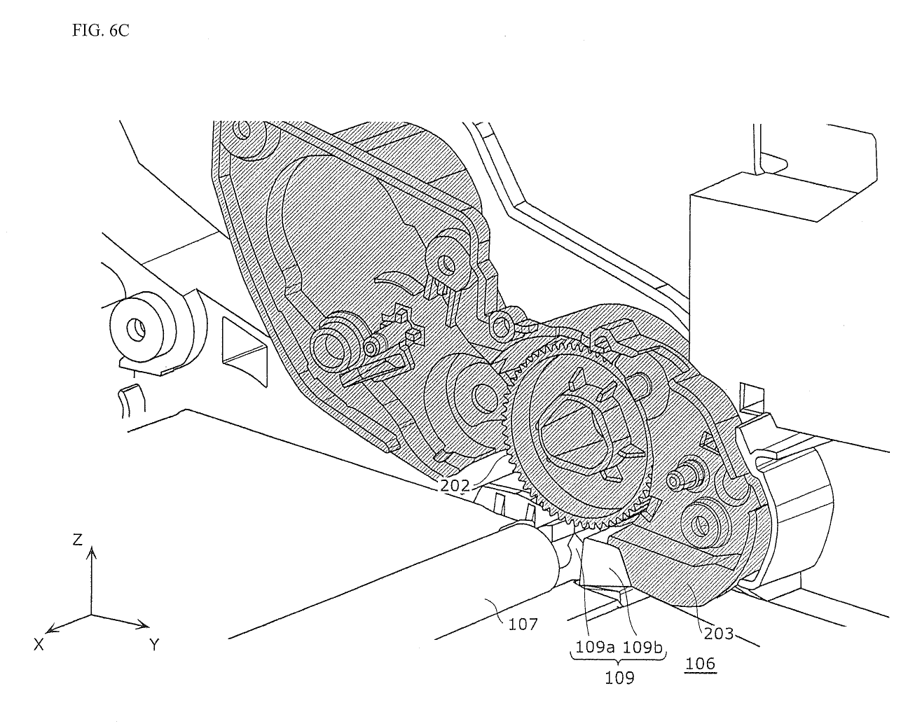

The mounting process of the cartridge 200 on the printer 100 configured as described above will be described below. FIGS. 6A to 6C are perspective views illustrating the mounting process of the cartridge 200 in the printer 100 according to one or more embodiments of the first example of the present invention. In the order from 6A to 6C, the cartridge 200 is mounted to the printer 100 proceeding in the Y-axis direction.

In FIGS. 6A to 6C, members of one portion of the cartridge 200 have been removed. In other words, from among the members included in the cartridge 200, only members around the vicinity of the second gear 202 are shown in FIGS. 6A to 6C. Furthermore, to distinguish between the printer 100 and the cartridge 200, hatching is added to the cartridge 200.

In FIG. 6A, the second gear 202 of the cartridge 200 is located more to the upstream side in the transporting direction (negative side of the Y-axis direction) than the first gear 108 of the printer 100. Moreover, the protruding portion 109 of the printer 100 does not contact the cartridge 200.

In FIG. 6B, the engaging portion 203 of the cartridge 200 contacts the protruding portion 109 of the printer 100. As a result, the first gear 108 of the printer 100 and the second gear 202 of the cartridge 200 are separated by a certain distance. In other words, the second gear 202 is separated from the first gear 108 in the Z-axis direction. Therefore contact between the first gear 108 and the second gear 202 is avoided.

For example, the engaging portion 203 moves in the Y-axis direction while contacting the protruding portion 109 (first protruding portion 109a and second protruding portion 109b) in the Z-axis direction when the second gear 202 of the cartridge 200 passes the upper part of the first gear 108 of the printer 100. That is, the engaging portion 203 moves to the positive side of the Y-axis direction while supporting a position higher (the positive side of the X-axis direction) than the mounting face 106. As a result, the second gear 202 surpasses the first gear 108 to the positive side of the Y-axis direction while supporting a position higher (the positive side of the X-axis direction) than the first gear 108.

In FIG. 6C, the engaging portion 203 of the cartridge 200 contacts the mounting face 106 of the printer 100. That is to say, the cartridge 200 moves lower (the negative side of the Z-axis direction) than the state in FIG. 6B. As a result, the second gear 202 of the cartridge 200 also moves downward (the negative side of the Z-axis direction) and engages the first gear 108.

In addition, the engaging portion 203 engages with the protruding portion 109 (here, the second protruding portion 109b) of the printer 100 in the Y-axis direction. As a result, the movement toward the upstream side in the transporting direction of the cartridge 200 is limited.

(Effects)

As described above, with the printer 100 according to embodiments of the present invention described above, the distance between the first gear 108 and the second gear 202 while the cartridge 200 is proceeding is restricted by the protruding portion 109 protruding from the mounting face 106. That is to say, the first gear 108 and the second gear 202 are separated in a direction crossing the mounting face 106 so that the first gear 108 and the second gear 202 do not contact while the cartridge 200 is proceeding. Therefore, the detaching of the cartridge 200 to the printer 100 can appropriately be assisted and lowering the flexibility in design of the printer 100 can be suppressed even if there is no mechanism provided on the inner side face of the printer 100 for preventing the contact of the first gear 108 and the second gear 202.

Furthermore, with the printer 100 according to embodiments of the present invention, the protruding portion 109 can be provided between the transfer roller 107 and the first gear 108 in the axis direction of the transfer roller 107. Therefore, the protruding portion 109 can be disposed in a region where a bearing of the transfer roller 107 is disposed, or a region where arranged in a direction that crosses the axis direction of that region and the transfer roller 107. As a result, the dimensions of the printer 100 in the axis direction of the transfer roller 107 can be reduced, thereby contributing to the size reduction of the printer.

Furthermore, with the printer 100 according to embodiments of the present invention, the protruding portion 109 can rotatably hold the transfer roller 107. That is to say, that a bearing of the transfer roller 107 can be used as the protruding portion 109 for restricting the distance between the first gear 108 and the second gear 202. Therefore, the length of the second protruding portion 109b in a direction crossing the axis direction of the transfer roller 107 can be reduced on the mounting face 106, thereby contributing to the size reduction of the printer 100.

Further, with the printer 100 according to embodiments of the present invention, the protruding portion 109 of the printer 100 and the engaging portion 203 of the cartridge 200 can be engaged in a direction crossing the axis direction of the transfer roller 107 on the mounting face 106. Therefore, the protruding portion 109 for restricting the distance between the first gear 108 and the second gear 202 when the cartridge 200 is being mounted can be used as a mechanism for restricting the movement of the cartridge 200 after the cartridge 200 has been mounted.

### Second Example

Embodiments of the second example of the present invention will be described in detail with reference to the drawings. Embodiments of the second example differ from embodiments of the first example in the fact that the first protruding portion of the printer has elasticity in a direction crossing the mounting face (the face that transports the recording medium). The printer according to embodiments of the second example will be described below focusing on the differences with the embodiments of the first example.

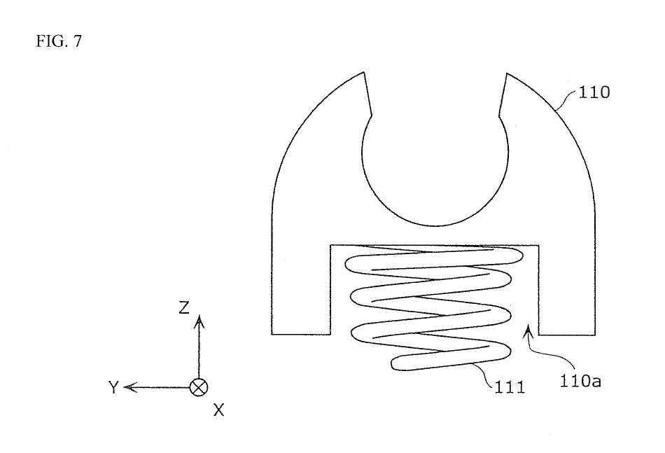

FIG. 7 is a diagram illustrating a first protruding portion 110 and an elastic member 111 of the printer according to one or more embodiments of the second example of the present invention.

As with the first protruding portion 109a according to embodiments of the first example of the present invention, the first protruding portion 110 rotatably holds the transfer roller 107 around the X-axis. In addition, the first protruding portion 110 has elasticity in a direction crossing the mounting face 106 (Z-axis direction).

In embodiments of the second example of the present invention, the first protruding portion 110 has elasticity in the Z-axis direction by the elastic member 111. Therefore, the first protruding portion 110 moves downward when pressure is applied from above and returns to the original position when the pressure from above is removed.

The elastic member 111 is disposed below the first protruding portion 110. Here, the elastic member 111 is a compression coil spring. The end face of the compression coil spring contacts the bottom face of a recessed portion 110a formed on the bottom portion of the first protruding portion 110.

As above, with the printer according to one or more embodiments of the present invention, the first protruding portion 110 can have elasticity in a direction crossing the mounting face 106. Therefore, shock can be alleviated when the cartridge 200 contacts the protruding portion 110, and the occurrence of damage to the printer 100 and the cartridge 200 can be reduced.

### Other Examples

Above, the printer according to embodiments of the present invention was described, but the present invention is not limited to these embodiments. As long as the main points of the present invention are not deviated from, various modifications applied by a person skilled in the art to these embodiments, and modes constructed by combining components from different embodiments are also included in the scope of the present invention.

For example, in embodiments of the present invention described above, it was described that the printer was a laser printer, but the present invention is not limited to this. For example, the printer may be an LED printer.

According to one or more embodiments of the present invention described above, the protruding portion included a first protruding portion and a second protruding portion, but the present invention is not limited to this. For example, the protruding portion may include only one of the first protruding portion and the second protruding portion.

The position of the protruding portion according to one or more embodiments of the present invention is one example, and the position of the protruding portion is not limited to the embodiments described above. For example, the protruding portion was provided between the transfer roller and the first gear in the axis direction of the transfer roller, but may also be provided more to the outer side than the first gear. In other words, the first gear may be provided between the transfer roller and the protruding portion.

According to one or more embodiments of the present invention, the protruding portion engages with the engaging portion of the cartridge, but it is not absolutely necessary to be configured in this manner. In other words, the protruding portion may only restrict the distance between the first gear 108 and the second 202 during the progression of the cartridge.

According to one or more embodiments of the second example of the present invention, the elastic member is a compression coil spring, but the present invention is not limited to this. The elastic member 111 may be, for example, a plate spring. Furthermore, the elastic member 111 may not be a spring. For example, the elastic member 111 may be rubber.

According to one or more embodiments of the second example of the present invention, the elastic member is separate from the first protruding portion, but may be formed integrally with the first protruding portion. For example, the bottom portion of the first protruding portion may be formed in a plate spring shape.

According to one or more embodiments of another example of the present invention, the engaging portion of the printer 100 (first engaging portion) and the engaging portion of the cartridge 200 (second engaging portion) engage when the cartridge 200 is mounted to the printer 100. At least one of the engaging portions of the printer 100 (first engaging portion) and the engaging portion of the cartridge 200 (second engaging portion) may have a shape that protrudes in a direction crossing a face that transports a recording medium. The shape that protrudes may cause the first gear 108 and the second gear 202 to be separated by a distance in the direction crossing the face that transports the recording medium until the first engaging portion engages with the second engaging portion after the cartridge 200 is inserted into the printer 100, and may contact the other of the first engaging portion and the second engaging portion.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### EXPLANATION OF REFERENCES

100 Printer
101 Housing
101a Side frame
102 Paper feeding cassette
103 Paper discharging tray
104 Front cover
104a Handle portion
105 Insertion opening
106 Mounting face
107 Transfer roller
108 First gear
109 Protruding portion
109a, 110 First protruding portion
109b Second protruding portion
111 Elastic member
200 Cartridge
201 Photoreceptor roller
202 Second gear
203 Engaging portion

What is claimed is:

1. An image forming apparatus that uses a cartridge, comprising:
a protruding portion that engages with an engaging portion of the cartridge; and
a first gear that engages with a second gear of the cartridge, wherein
while the cartridge is being inserted into the image forming apparatus, the protruding portion maintains a distance of separation, between the first gear and the second gear in a direction crossing a face that transports a recording medium, until the protruding portion engages with the engaging portion.

2. The image forming apparatus according to claim 1, wherein the protruding portion protrudes from the face.

3. The image forming apparatus according to claim 1, further comprising:
a transfer roller, wherein
the protruding portion is disposed between the transfer roller and the first gear in an axis direction of the transfer roller.

4. The image forming apparatus according to claim 1, wherein the protruding portion is disposed further downstream than the first gear in a transporting direction of the recording medium.

5. The image forming apparatus according to claim 1, wherein
the cartridge comprises a photoreceptor roller,
the second gear connects to the photoreceptor roller, and
the photoreceptor roller rotates by the first gear and the second gear engaging.

6. The image forming apparatus according to claim 5, wherein the engaging portion is disposed further downstream than the photoreceptor roller along a transporting direction of the recording medium and toward an insertion direction of the cartridge.

7. The image forming apparatus according to claim 1, further comprising:
a transfer roller, wherein
the protruding portion comprises:
a first protruding portion that rotatably holds the transfer roller and protrudes from the face, and
a second protruding portion that is arranged with the first protruding portion in a direction crossing an axis direction of the transfer roller and protrudes from the face.

8. The image forming apparatus according to claim 7, wherein the first protruding portion has elasticity in a direction crossing the face.

9. The image forming apparatus according to claim 1, wherein the protruding portion engages with the engaging portion in a transporting direction of the recording medium.

10. A cartridge mounted on an image forming apparatus, comprising:
an engaging portion that engages with a protruding portion of the image forming apparatus;
a second gear that engages with a first gear of the image forming apparatus, wherein
while the cartridge is being inserted into the image forming apparatus, the engaging portion maintains a distance of separation, between the first gear and the second gear in a direction crossing a face that transports a recording medium, until the engaging portion engages with the protruding portion.

11. The cartridge according to claim 10, further comprising:
a photoreceptor roller, wherein
the second gear connects to the photoreceptor roller, and
the photoreceptor roller rotates by the first gear and the second gear engaging.

12. The cartridge according to claim 11, wherein the engaging portion is disposed further downstream than the photoreceptor roller along a transporting direction of the recording medium and toward an insertion direction of the cartridge.

13. A method for mounting a cartridge to an image forming apparatus, the method comprising:
inserting the cartridge into the image forming apparatus;
engaging a first engaging portion of the image forming apparatus with a second engaging portion of the cartridge;
engaging a first gear of the image forming apparatus with a second gear of the cartridge, wherein at least one of the first engaging portion and the second engaging portion protrudes in a direction crossing a face that transports a recording medium; and
while the cartridge is being inserted into the image forming apparatus, maintaining a distance of separation between the first gear and the second gear in the direction crossing the face that transports the recording medium, until the first engaging portion engages with the second engaging portion.

14. The method according to claim 13, wherein
the image forming apparatus comprises a transfer roller, and
the first engaging portion is disposed between the transfer roller and the first gear in an axis direction of the transfer roller.

15. The method according to claim 13, wherein the first engaging portion is disposed further downstream than the first gear in a transporting direction of the recording medium.

16. The method according to claim 13, wherein
the cartridge comprises a photoreceptor roller,
the second gear connects to the photoreceptor roller, and
the photoreceptor roller rotates by the first gear and the second gear engaging.

17. The method according to claim 16, wherein the second engaging portion is disposed further downstream than the photoreceptor roller along a transporting direction of the recording medium and toward an insertion direction of the cartridge.

18. The method according to claim 13, wherein
the image forming apparatus comprises a transfer roller, and
the at least one of the first engaging portion and the second engaging portion comprises:
a first portion that rotatably holds the transfer roller and protrudes from the face, and
a second portion that is arranged with the first portion in a direction crossing an axis direction of the transfer roller and protrudes from the face.

19. The method according to claim 18, wherein the first portion has elasticity in a direction crossing the face.
